(19) United States
(12) Patent Application Publication
(10) Pub. No.: US 2011/0180600 A1
(43) Pub. Date: Jul. 28, 2011

(54) INFORMATION PROCESSING APPARATUS, COMMODITY INFORMATION PROCESSING SYSTEM, INFORMATION PROCESSING METHOD, AND COMMODITY INFORMATION PROCESSING METHOD

(75) Inventors: Yun Wang, Kanagawa (JP); Keiichi Haseagawa, Tokyo (JP); Kenji Terasaki, Chiba (JP)

(73) Assignee: TOSHIBA TEC KABUSHIKI KAISHA, Tokyo (JP)

(21) Appl. No.: 13/013,076

(22) Filed: Jan. 25, 2011

(30) Foreign Application Priority Data
Jan. 26, 2010 (JP) 2010-014609

(51) Int. Cl. G06K 15/02

(52) U.S. Cl. 235/383

(57) ABSTRACT

According to one embodiment, an information processing apparatus includes: a readout unit configured to read out, from a storing unit, operation unit information including pieces of allocated information respectively allocated to plural operation units configured to receive selection operation; a data generating unit configured to generate print data of a code symbol display medium on which code symbols obtained by respectively symbolizing the pieces of allocated information are displayed; and a data output unit configured to output the print data to an output unit.

### CROSS-REFERENCE TO RELATED APPLICATION

This application is based upon and claims the benefit of priority from the prior Japanese Patent Application No. 2010-14609, Jan. 26, 2010 the entire contents of which are incorporated herein by reference.

### FIELD

Embodiments described herein relate generally to an information processing apparatus, a commodity information processing system, an information processing method, and a commodity information processing method.

### BACKGROUND

In the past, as a commodity information processing system for a store such as a supermarket, for example, there has been a commodity information processing system in which a provisional registration system is incorporated in a checkout system including a POS terminal. In the provisional registration system, a portable terminal carried by a store clerk provisionally registers a commodity according to operation by the store clerk before checkout processing by the POS terminal set in a checkout area of a store. The portable terminal issues, with a printer, a provisional receipt on which a barcode of the provisionally-registered commodity is printed (see, for example, Japanese Patent No. 3632019). The barcode is obtained by symbolizing a code including a predetermined number of digits into a stripe pattern shape including bars and spaces. As the provisional registration of the commodity, a scanner reads the barcode attached to the commodity and acquires the code of the commodity as electronic data on the basis of the read barcode.

A customer passes the provisional receipt issued by the provisional registration system to a cashier in the checkout area of the store. The cashier causes a scanner connected to the POS terminal to read the barcode printed on the provisional receipt. The POS terminal executes the checkout processing on the basis of the barcode read by the scanner.

Among commodities in the supermarket, there is a commodity such as a commodity sold loose to which a code is given but a barcode is not attached. The barcode of such a commodity is displayed on a barcode sheet serving as a code symbol display medium. JP-A-07-175863 discloses an example of the barcode sheet. By using the barcode sheet in this way, it is possible to easily provisionally register even the commodity to which the barcode is not attached.

However, a creator of the barcode sheets is first forced to input respective kinds of code information concerning individual commodities, which require barcodes, to a label printer. The label printer separately issues labels on which the barcodes are individually displayed. Thereafter, the sheet creator has to perform work for respectively sticking barcode labels separately issued for each of the commodities to sheets. Therefore, it takes time and labor to create such barcode sheets.

### DESCRIPTION OF THE DRAWINGS

FIG. 1 is a diagram of a schematic configuration of a commodity information processing system according to an embodiment;

FIG. 2 is a perspective view of a portable terminal according to the embodiment viewed from the front surface side thereof;

FIG. 3 is a perspective view of the portable terminal according to the embodiment viewed from the rear surface side thereof;

FIG. 4 is a diagram of a schematic configuration of the portable terminal according to the embodiment;

FIG. 5 is a plan view of a provisional receipt according to the embodiment;

FIG. 6 is a diagram of a schematic configuration of a POS terminal according to the embodiment;

FIG. 7 is a perspective view of a barcode scanner according to the embodiment;

FIG. 8 is a diagram of a selection screen displayed on a display of the barcode scanner according to the embodiment;

FIG. 9 is a diagram of a schematic configuration of a store server according to the embodiment;

FIG. 10 is a diagram of a functional configuration of a CPU of the store server according to the embodiment;

FIG. 11 is a diagram of a code sheet according to the embodiment; and

FIG. 12 is a flowchart for explaining a flow of barcode sheet issue processing performed by the CPU of the store server according to the embodiment.

### DETAILED DESCRIPTION

An embodiment makes it possible to relatively easily create a medium on which code symbols are displayed.

In general, according to one embodiment, an information processing apparatus includes: a readout unit configured to read out, from a storing unit, operation unit information including pieces of allocated information respectively allocated to plural operation units configured to receive selection operation; a data generating unit configured to generate print data of a code symbol display medium on which code symbols obtained by respectively symbolizing the pieces of allocated information are displayed; and a data output unit configured to output the print data to an output unit.

According to another embodiment, a commodity information processing system includes, an information processing apparatus, an output unit, a portable terminal, and a settlement apparatus. The information processing apparatus includes: a readout unit configured to read out, from a storing unit, operation unit information including commodity identification information, which is identification information concerning commodities, and including pieces of allocated information respectively allocated to plural operation units configured to receive selection operation; a data generating unit configured to generate print data of a code symbol display medium on which code symbols obtained by respectively symbolizing the pieces of allocated information are displayed; and a data output unit configured to output the print data. The output unit issues the code symbol display medium using the print data output by the data output unit. The portable terminal reads the code symbols displayed on the code symbol display medium issued by the output unit. The settlement apparatus performs settlement of the commodities, the code symbols of which are read by the portable terminal.

According to still another embodiment, an information processing method includes: a readout unit reading out, from a storing unit, operation unit information including pieces of allocated information respectively allocated to plural operation units configured to receive selection operation; a data generating unit generating print data of a code symbol display medium on which code symbols obtained by respectively symbolizing the pieces of allocated information are displayed; and a data output unit outputting the print data to an output unit.

According to still another embodiment, a commodity information processing method is a commodity information processing method executed by a commodity information processing system including: an information processing apparatus including a readout unit, a data generating unit, and a data output unit; an output unit; a portable terminal; and a settlement apparatus, the commodity information processing method including: the readout unit reading out, from a storing unit, operation unit information including commodity identification information, which is identification information concerning commodities, and including pieces of allocated information respectively allocated to plural operation units configured to receive selection operation; the data generating unit generating print data of a code symbol display medium on which code symbols obtained by respectively symbolizing the pieces of allocated information are displayed; the data output unit outputting the print data; the output unit issuing the code symbol display medium using the print data output by the data output unit; the portable terminal reading the code symbols displayed on the code symbol display medium issued by the output unit; and the settlement apparatus performing settlement of the commodities, the code symbols of which are read by the portable terminal.

Exemplary embodiments of an information processing apparatus, a commodity information processing system, an information processing method, and a commodity information processing method will be explained below in detail with reference to the accompanying drawings.

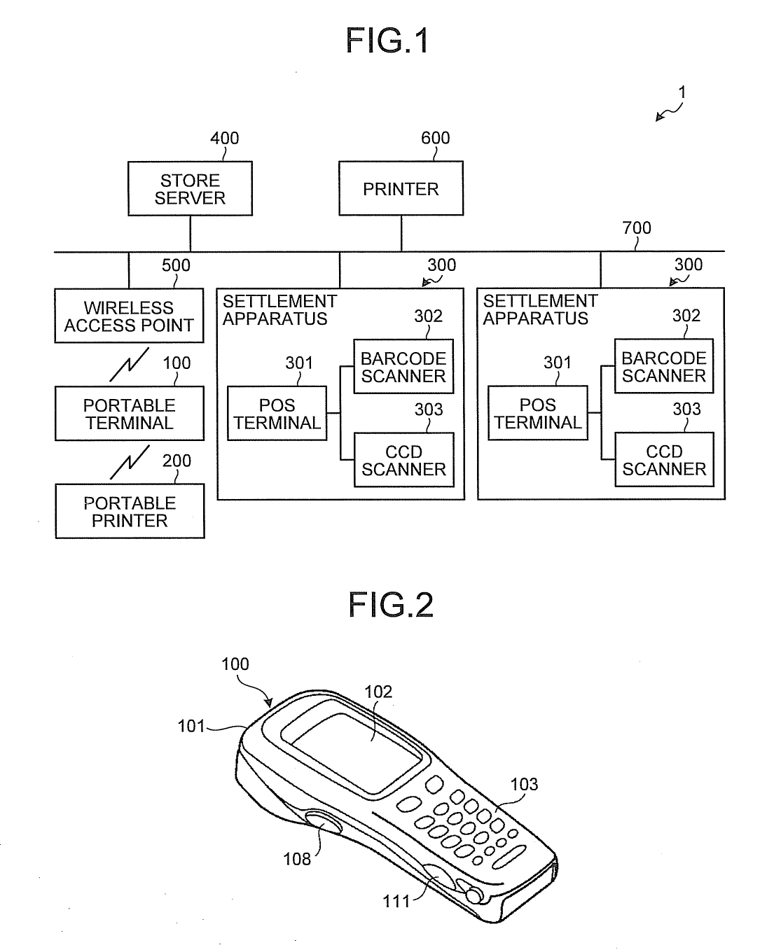

As shown in FIG. 1, a commodity information processing system 1 includes a portable terminal 100, a portable printer 200, settlement apparatuses 300, a store server 400 as an information processing apparatus, a wireless access point 500, and a printer 600 as an output unit. The settlement apparatuses 300, the store server 400, the wireless access point 500, and the printer 600 are connected by a wired communication network 700 such as a wired local area network (LAN). The portable terminal 100 is connected to the wireless access point 500 and the portable printer 200 by wireless communication. In this embodiment, the portable terminal 100, the portable printer 200, and the store server 400 configure a provisional registration system.

The commodity information processing system 1 is set in a store in which provisional registration processing is performed. Before settlement of commodities of a customer waiting for settlement in each of the settlement apparatuses 300, the commodity information processing system 1 provisionally registers, with the portable terminal 100 operated by a store clerk, the commodities of the customer and issues, with the portable printer 200, a provisional receipt 800 (see FIG. 5) on which information concerning the provisionally registered commodities are displayed. When the settlement is performed, the customer passes the provisional receipt 800 to a cashier. The cashier who receives the provisional receipt 800 performs operation for inputting the information concerning the commodities displayed on the provisional receipt 800 to the settlement apparatus 300. Consequently, the settlement apparatus 300 performs the settlement of the commodities.

The units of the commodity information processing system 1 are explained in detail below.

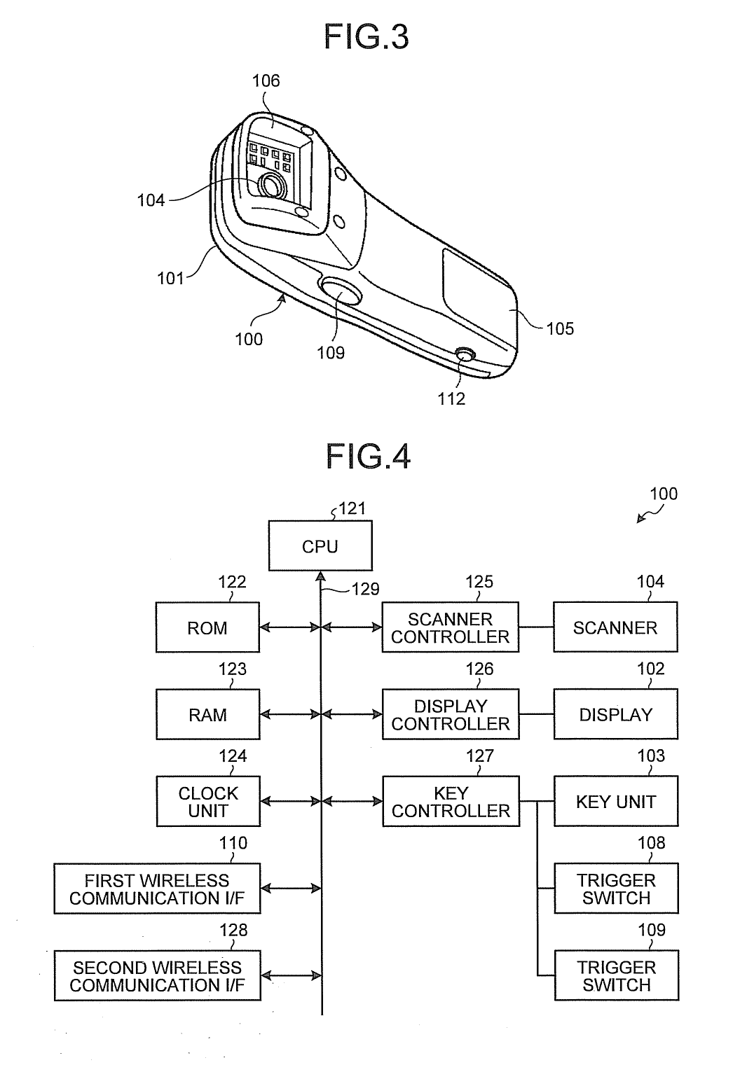

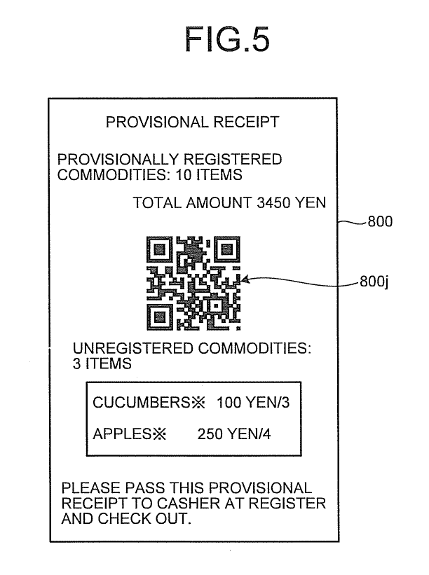

The portable terminal 100 is a portable information processing terminal operated by the store clerk or the like of the store and is configured as a computer. As shown in FIGS. 2 and 3, the portable terminal 100 is formed in a substantially rectangular parallelepiped shape in external appearance. The portable terminal 100 is configured to allow the store clerk carrying the portable terminal 100 to operate the same with one hand. The portable terminal 100 includes a display 102 such as a liquid crystal display and a key unit 103 on the front surface of a housing 101. The portable terminal 100 includes a scanner 104, which is a first reading unit, and a battery 105 on the rear surface of the housing 101. In the portable terminal 100, a code reading opening 106 of the scanner 104 is formed on the rear surface of the housing 101. The portable terminal 100 includes trigger switches 108 and 109 in substantially the centers on both the left and right side surfaces of the housing 101. The trigger switches 108 and 109 are used as a trigger in reading a code symbol such as a barcode with the scanner 104. A light projecting and receiving window 111 of a first wireless communication interface 110 (see FIG. 4) is formed in a lower part on the left side surface of the housing 101.

The battery 105 is detachably attached to a lower part of the rear surface of the housing 101. When a release switch 112 provided in a lower part on the right side surface of the housing 101 is operated, the battery 105 is removed from the housing 101. The portable terminal 100 operates with electric power of the battery 105.

The key unit 103 includes a ten key including number keys of “0” to “9” and a decimal point key, an enter key, a clear key, and a power key.

The scanner 104 optically reads barcodes attached to commodities. Commodity codes as commodity identification information are set for the commodities. The commodity codes are attached to the commodities in a form of the barcodes.

The portable terminal 100 includes, as shown in FIG. 4, a central processing unit (CPU) 121, a read only memory (ROM) 122, a random access memory (RAM) 123, and a clock unit 124 configured to measure date and time. The CPU 121, the ROM 122, the RAM 123, and the clock unit 124 are connected via a bus line 129 such as an address bus or a data bus and configure a control unit.

The CPU 121 executes computer-readable various computer programs stored in the ROM 122 to thereby control the portable terminal 100. The ROM 122 has stored therein the various computer programs to be executed by the CPU 121 and various data. The RAM 123 temporarily stores the various computer programs to be executed by the CPU 121 and rewritably stores the various data. A power supply for the RAM 123 is backed up by the battery 105. The data stored in the RAM 123 is maintained even when the power supply is turned off.

The portable terminal 100 further includes a scanner controller 125, a display controller 126, a key controller 127, the first wireless communication interface (in the figure, I/F) 110, and a second wireless communication interface (in the figure, I/F) 128. The scanner controller 125, the display controller 126, the key controller 127, the first wireless communication interface 110, and the second wireless communication interface 128 are connected to the CPU 121 by the bus line 129.

The scanner controller 125 captures a signal of data read by the scanner 104 and inputs the signal to the CPU 121. The display controller 126 controls driving of the display 102 and causes the display 102 to display characters or the like corresponding to display data given from the CPU 121. The key controller 127 captures signals output from the key unit 103 and the trigger switches 108 and 109 and notifies the CPU 121 of the signals.

The first wireless communication interface 110 controls wireless data communication with the portable printer 200. Wireless communication between the portable terminal 100 and the portable printer 200 may be communication by a radio wave, light, an infrared ray, or ultrasound, proximity wireless communication (e.g., Bluetooth (registered trademark)), or the like. In this embodiment, the infrared ray is used.

The second wireless communication interface 128 controls wireless data communication with the wireless access point 500. The portable terminal 100 performs, with the first wireless communication interface 110, data communication with other apparatuses such as the store server 400 via the wireless access point 500. In this embodiment, the portable terminal 100 and the wireless access point 500 configure a wireless LAN system employing a wireless LAN scheme.

The portable printer 200 issues, for example, the provisional receipt 800 (FIG. 5) as an information display medium on which information is displayed. The portable printer 200 is, for example, a printer of a line thermal type that uses, as sheets, roll paper wound in a roll shape. The portable printer 200 prints, while drawing out the roll paper wound in the roll shape, information on the roll paper and generates the provisional receipt 800, cuts off the provisional receipt 800 from the roll paper, and issues the provisional receipt 800. The portable printer 200 includes a control unit (not shown) including a CPU, a ROM, and a RAM and a wireless communication interface (not shown) connected to the control unit. The portable printer 200 performs wireless data communication with the portable terminal 100 through the wireless communication interface.

The settlement apparatus 300 includes, as shown in FIG. 1, a point of sales (POS) terminal 301 as a computer, a barcode scanner 302 connected to the POS terminal 301, and a charge coupled device (CCD) scanner 303 connected to the POS terminal 301.

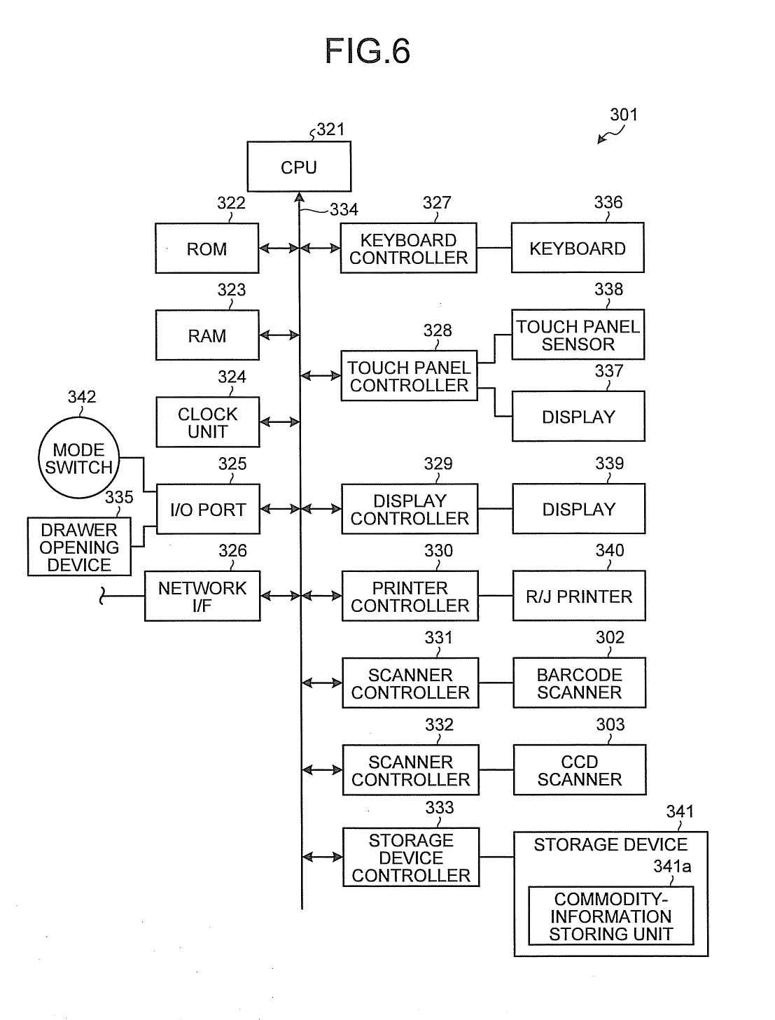

The POS terminal 301 includes, as shown in FIG. 6, a CPU 321, a ROM 322, a RAM 323, a clock unit 324, an input and output (I/O) port 325, a network interface 326, a keyboard controller 327, a touch panel controller 328, a display controller 329, a printer controller 330, scanner controllers 331 and 332, and a storage device controller 333. These devices are connected via a bus line 334 such as an address bus or a data bus.

The CPU 321 executes computer-readable various computer programs stored in the ROM 322 to thereby control the POS terminal 301. The ROM 322 has stored therein the various computer programs to be executed by the CPU 321 and various data. The RAM 323 stores the various computer programs to be executed by the CPU 321 and various data.

The clock unit 324 measures the present date and time. The network interface 326 controls data communication with other apparatuses connected through the wired communication network 700 or the like. The I/O port 325 receives input of a mode selection signal from a mode switch 342 and outputs a driving signal to a drawer opening device 335 configured to automatically open a drawer (not shown). The keyboard controller 327 captures a key signal corresponding to an operation key from a keyboard 336 and notifies the CPU 321 of the key signal. The touch panel controller 328 controls driving of a display with touch panel for customer 337 and causes the display with touch panel for customer 337 to display, in color, characters or the like corresponding to display data supplied from the CPU 321. The touch panel controller 328 captures a signal from a touch panel sensor 338 attached to a screen of the display 337 and notifies the CPU 321 of the signal. The display controller 329 controls driving of a display for operator 339 and causes the display for operator 339 to display, in color, characters or the like corresponding to display data given from the CPU 321. The printer controller 330 controls driving of a receipt and journal (in the figure, R/J) printer 340 and causes the receipt and journal printer 340 to perform receipt printing and journal printing on the basis of print data supplied from the CPU 321. The scanner controller 331 captures a signal of data read by the barcode scanner 302 and inputs the signal to the CPU 321. The scanner controller 332 captures a signal of data read by the CCD scanner 303 and inputs the signal to the CPU 321. The storage device controller 333 controls writing and readout of data in and from a storage device 341 on the basis of an instruction signal from the CPU 321.

The storage device 341 includes, for example, a hard disk drive device. The storage device 341 has stored therein, for example, a computer program for causing the CPU 321 to operate. The storage device 341 includes a commodity-information storing unit 341a configured to store commodity data that indicates various kinds of information concerning commodities. The commodity data stored in the commodity-information storing unit 341a is a copy of commodity data stored in the store server 400 explained later. The commodity data includes commodity codes, commodity names, and unit prices of commodities.

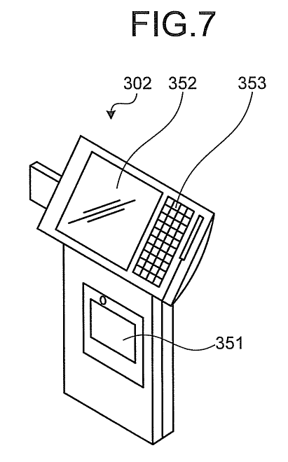

The barcode scanner 302 is a vertical scanner. The barcode scanner 302 includes, as shown in FIG. 7, a scanner unit 351 configured to optically read a barcode, which is a code symbol attached to a commodity, a display 352 including a touch panel arranged on a display surface, and a keyboard 353.

The barcode scanner 302 includes, for example, a control unit (not shown) having a computer configuration including a CPU, a RAM, and a ROM and a storage device. The control unit controls the barcode scanner 302.

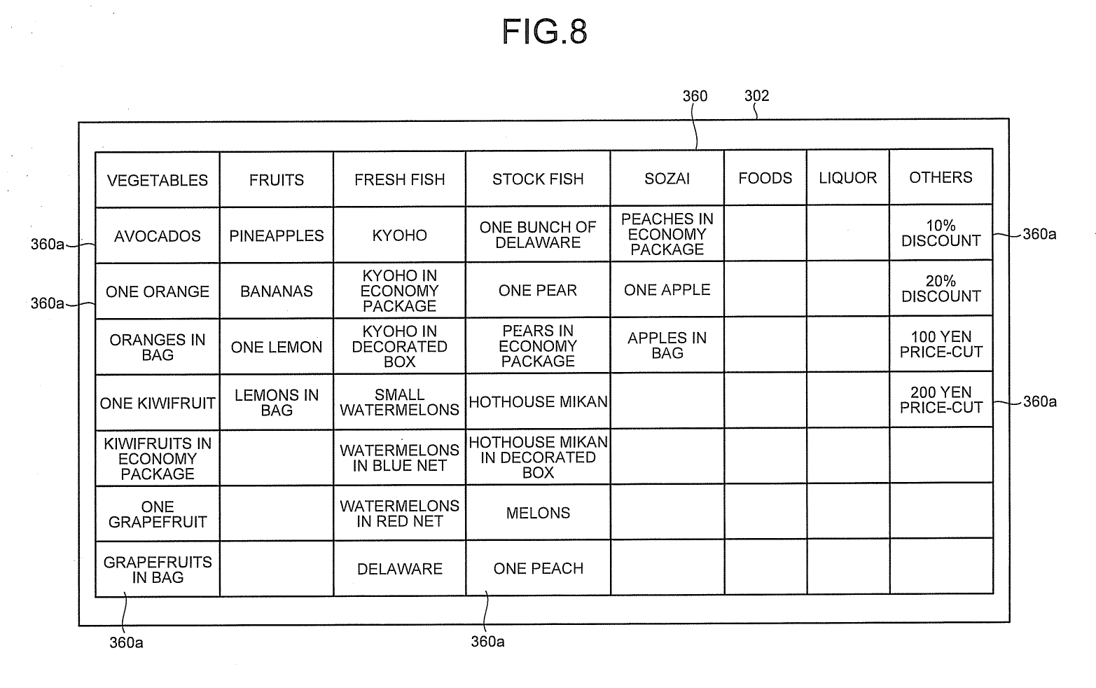

The control unit of the barcode scanner 302 displays a selection screen 360 shown in FIG. 8 on the display 352. The selection screen 360 includes plural preset buttons 360a as operation units configured to receive selection operation. The preset buttons 360a are selected and operated by an operator via the touch panel. The preset buttons 360a are arranged in a matrix shape. Examples of the preset buttons 360a include the preset buttons 360a on which commodities (e.g., “avocados” and “one orange”) are displayed and the preset buttons 360a on which discounts for commodities (e.g., “10% discount” and “200 yen price-cut”) are displayed. Allocated information is allocated to the preset buttons 360a. For example, commodity codes as commodity identification information concerning displayed commodities are allocated to the preset buttons 360a on which the commodities are displayed. Discount identification information as identification information of displayed discount information is allocated to the preset buttons 360a on which the discounts for the commodities are displayed. The allocated information is included in operation unit information stored in the storage device of the barcode scanner 302.

The operation unit information includes identification information (e.g., numbers) concerning the preset buttons 360a, the allocated information allocated to the preset buttons 360a, and position information concerning the preset buttons 360a. The allocated information allocated to the preset buttons 360a, the position information concerning the preset buttons 360a, and the like are associated with the identification information concerning the preset buttons 360a corresponding to the allocated information, the position information, and the like. The allocated information is, for example, the commodity codes as the commodity identification information and the discount identification information. The operation unit information is a copy of operation unit information stored in an operation-unit-information storing unit 434b of the store server 400 explained later. The operation unit information is distributed from the store server 400 to the barcode scanner 302.

In the barcode scanner 302 having the configuration explained above, the control unit outputs information concerning a barcode read by the scanner unit 351 to the POS terminal 301, which is an external apparatus. In the barcode scanner 302, the control unit detects, according to an output signal of the touch panel, selection operation for the preset button 360a by a touch on the touch panel, reads out the allocated information associated with the selected and operated preset button 360a from the storage device, and outputs the allocated information to the POS terminal 301.

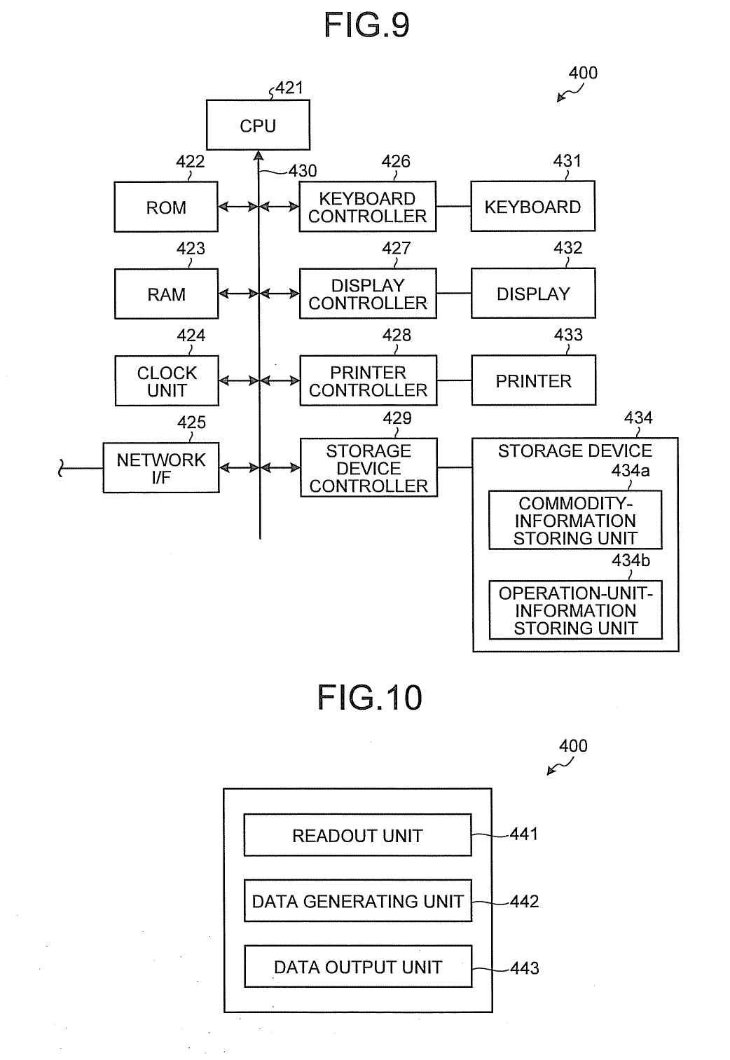

The store server 400 includes, as shown in FIG. 9, a CPU 421, a ROM 422, a RAM 423, a clock unit 424, a network interface (in the figure, I/F) 425, a keyboard controller 426, a display controller 427, a printer controller 428, and a storage device controller 429. These devices are connected via a bus line 430 such as an address bus or a data bus.

The CPU 421 executes computer-readable various computer programs stored in the ROM 422 to thereby control the store server 400. The ROM 422 has stored therein the various computer programs to be executed by the CPU 421 and various data. The RAM 423 stores the various computer programs to be executed by the CPU 421 and various data.

The clock unit 424 measures the present date and time. The network interface 425 controls data communication with other apparatuses connected through the wired communication network 700 or the like. The store server 400 is enabled to perform data communication with the portable terminal 100 and the POS terminal 301 of the settlement apparatus 300 by the wired communication network 700. The keyboard controller 426 captures a key signal corresponding to an operation key from a keyboard 431 and notifies the CPU 421 of the key signal. The display controller 427 controls driving of a display 432 and causes the display 432 to display, in color, characters or the like corresponding to display data given from the CPU 421. The printer controller 428 controls driving of a printer 433 and causes the printer 433 to perform printing on a sheet on the basis of print data supplied from the CPU 421. The storage device controller 429 controls writing and readout of data in and from a storage device 434 on the basis of an instruction signal from the CPU 421.

The storage device 434 includes, for example, a hard disk drive device. The storage device 434 has stored therein, for example, a computer program for causing the CPU 421 to operate. The storage device 434 includes a commodity-information storing unit 434a configured to store commodity data that indicates various kinds of information concerning commodities and the operation-unit-information storing unit 434b as the storing unit.

The commodity-information storing unit 434a has stored therein commodity information such as names and unit prices of commodities in association with commodity codes (e.g., JAN codes and in-store codes), which are commodity identification information. The commodity-information storing unit 434a has stored therein discount quantities (e.g., discount amounts and discount rates) in association with discount identification information.

The operation-unit-information storing unit 434b has stored therein operation unit information. The operation unit information includes identification information (e.g., numbers) concerning the preset buttons 360a, allocated information allocated to the preset buttons 360a, and position information concerning the preset buttons 360a. The allocated information allocated to the preset buttons 360a, the position information concerning the preset buttons 360a, and the like are associated with the identification information concerning the preset buttons 360a corresponding to the allocated information, the position information, and the like. The position information concerning the plural preset buttons 360a forms array information concerning the preset buttons 360a. In other words, the operation unit information includes the array information concerning the preset buttons 360a. The allocated information is, for example, commodity codes as commodity identification information, which is identification information concerning commodities, and discount identification information. The allocated information is rewritably set by preset button setting processing performed by the store server 400.

In the preset button setting processing, the store server 400 receives predetermined operation and displays a preset button setting screen (not shown) on the display 432. On the preset button setting screen, an allocated information area for receiving input of allocated information is displayed for each of pieces of the identification information (in this embodiment, numbers) concerning the preset buttons 360a. The store server 400 stores information input to the allocated information area in the operation-unit-information storing unit 434b in association with the identification information concerning the preset buttons 360a corresponding to the information to generate preset button setting information. The store server 400 transmits the generated preset button setting information to the barcode scanner 302. The processing explained above is executed by the CPU 421 operating as setting unit.

The wireless access point 500 is a wireless communication apparatus for connecting an apparatus (e.g., the store server 400) connected to the wired communication network 700 and the portable terminal 100. The wireless access point 500 performs protocol conversion between a wireless LAN and a wired LAN. The wireless access point 500 can be configured as, for example, a computer including a control unit including a CPU, a ROM, and a RAM, a network interface, and a wireless communication interface.

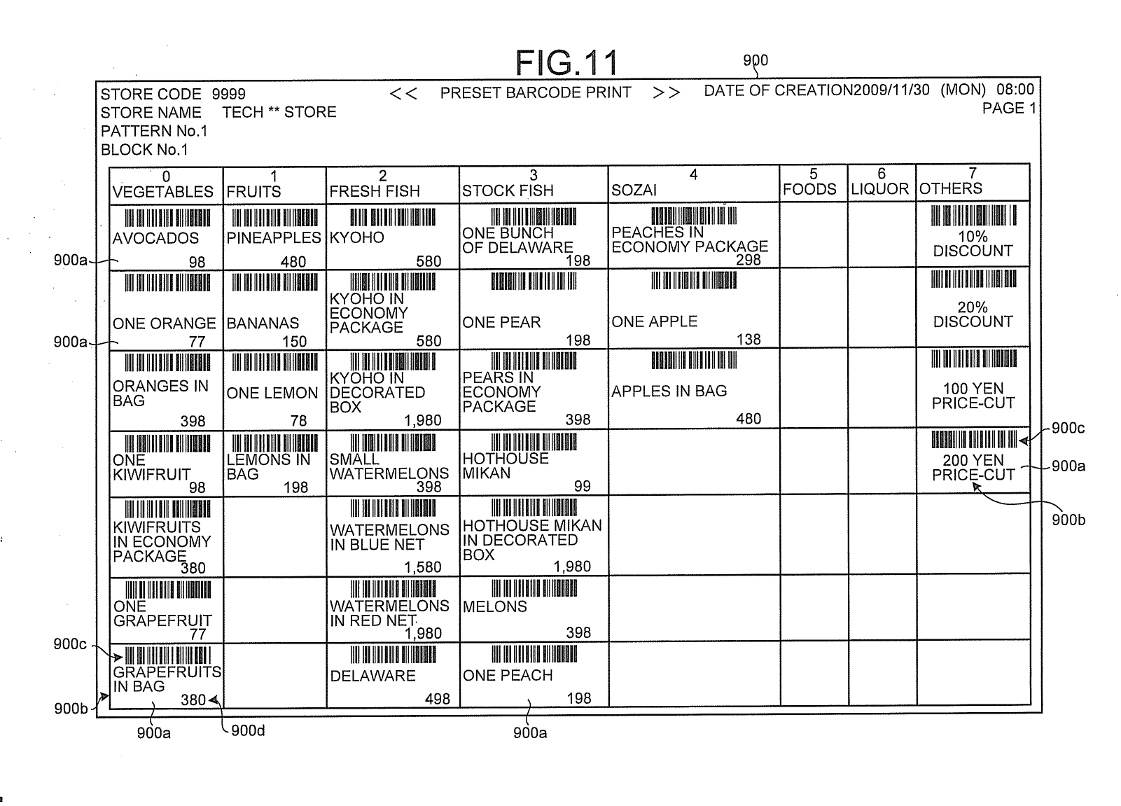

The printer 600 issues a sheet, which is an information display medium on which information is printed, using print data received from an external apparatus. The sheet is, for example, a barcode sheet 900 as a code symbol display medium shown in FIG. 11. The printer 600 may be a thermal printer, a printer of an ink-jet type, or a printer of an electrophotographic type that performs printing using a toner.

Among the various kinds of processing performed by the commodity information processing system 1, barcode sheet issue processing, provisional registration processing, and checkout processing are explained.

First, the barcode sheet issue processing is explained. The store server 400 performs the barcode sheet issue processing. The CPU 421 of the store server 400 realizes, according to computer programs, a readout unit 441, a data generating unit 442, and a data output unit 443 as functional units as shown in FIG. 10.

The readout unit 441 functions as readout means. The readout unit 441 reads out, from the operation-unit-information storing unit 434b as the storing unit, the operation unit information including the pieces of allocated information respectively allocated to the plural preset buttons 360a of (the display 352 of) the barcode scanner 302. The readout unit 441 reads out related information concerning the allocated information from the commodity-information storing unit 434a. Specifically, the readout unit 441 reads out the names, the unit prices, and the discount quantities of the commodities stored in the commodity-information storing unit 434a in relation to the commodity codes as the allocated information and the discount identification information. In this embodiment, the names, the unit prices, and the discount quantities of the commodities are the related information concerning the allocated information. The commodity-information storing unit 434a having the related information stored therein functions as a second storing unit.

The data generating unit 442 functions as data generating means. The data generating unit 442 generates print data of the barcode sheet 900 on which plural barcodes 900c, which are code symbols obtained by respectively symbolizing the pieces of allocated information allocated to the plural preset buttons 360a, are displayed. In order to symbolize the allocated information and display the symbolized allocated information on the barcode sheet 900, the data generating unit 442 converts the allocated information read out by the readout unit 441 into code symbol data. At this point, the data generating unit 442 converts the allocated information into the code symbol data on the basis of a rule for specifying the shape and the like of a barcode.

As shown in FIG. 11, on the barcode sheet 900, plural code display sections 900a corresponding to the preset buttons 360a are displayed. The code display sections 900a include the barcodes 900c in rectangular frames. The array of the plural code display sections 900a is the same as the array of the preset buttons 360a corresponding to the code display sections 900a. In other words, the array of the plural barcodes 900c is the same as the array of the plural preset buttons 360a corresponding to the barcodes 900c.

On the barcode sheet 900, related information corresponding to the barcodes 900c is displayed as character information 900b for each of the barcodes 900c. Specifically, in the code display sections 900a, related information concerning the barcodes 900c included in the code display sections 900a is displayed as the character information 900b (e.g., “avocados 98”, “grapefruits in bag 380”, “10% discount”, and “200 yen price-cut”). From the viewpoint of the allocated information indicated by the barcodes 900c, the pieces of information such as “avocados”, “grapefruits in bag”, “10% discount”, and “200 yen price-cut” are names given to the allocated information. In other words, in this embodiment, the character information 900b includes the names given to the allocated information. When contents indicated by the code display sections 900a are commodities, unit prices 900d (e.g., “380”) of the commodities are included in the character information 900b.

Such a barcode sheet 900 includes the barcodes 900c that indicate commodity codes, which are commodity identification information. Specifically, the barcodes 900c are barcodes displayed in the code display section 900a that indicate commodities such as “avocados”. The barcode sheet 900 includes the barcodes 900c that indicate discount information concerning commodities. Specifically, the barcodes 900c are the barcodes 900c displayed in the code display sections 900a that indicate discount information such as “200 yen price-cut”.

The data output unit 443 functions as data output means. The data output unit 443 outputs the print data generated by the data generating unit 442 to the printer 600 as the output unit. Consequently, the printer 600 prints and issues the barcode sheet 900 using the print data output by the data output unit 443.

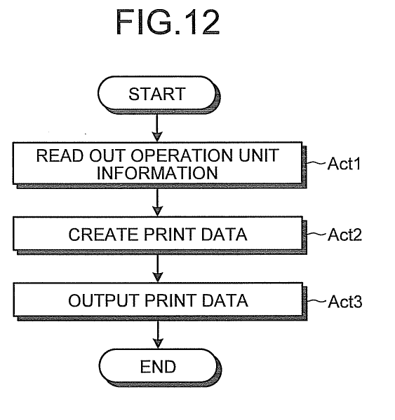

A flow of the barcode sheet issue processing is explained below with reference to a flowchart of FIG. 12. The store server 400 performs the barcode sheet issue processing when barcode sheet issue processing in a menu screen displayed on the display 432 is selected by operation by the operator via the keyboard 431.

First, the CPU 421 of the store server 400 operates as the readout unit 441 and reads out, from the operation-unit-information storing unit 434b, the operation unit information including the allocated information allocated to the preset buttons 360a of the barcode scanner 302 (Act 1). In Act 1, the CPU 421 reads out the related information concerning the read-out allocated information from the commodity-information storing unit 434a. Subsequently, the CPU 421 operates as the data generating unit 442 and generates print data of the barcode sheet 900 using the operation unit information read out in Act 1 (Act 2). The CPU 421 operates as the data output unit 443 and outputs the print data generated in Act 2 to the printer 600 (Act 3). The printer 600 that receives the print data prints and issues the barcode sheet 900 using the print data.

The provisional registration processing is explained below. In the provisional registration processing, according to operation by a store clerk, the portable terminal 100 reads, with the scanner 104, commodity codes attached to commodities held by a customer waiting for checkout. At this point, concerning commodities not attached with barcodes and large commodities, the portable terminal 100 reads, with the scanner 104, the barcodes 900c of the barcode sheet 900. The portable terminal 100 generates commodity information including the commodity codes read by the scanner 104 and causes the storing unit such as the RAM 123 to store the commodity information. In this way, the portable terminal 100 provisionally registers the commodities, the commodity codes of which are read by the scanner 104. The portable terminal 100 generates provisionally registered commodity specifying information including all the commodity codes of the provisionally registered commodities and causes the portable printer 200 to issue the provisional receipt 800 on which the provisionally registered commodity specifying information is displayed. In this embodiment, as shown in FIG. 5, the provisionally registered commodity specifying information is shown in a form of a two-dimensional code on the provisional receipt 800.

The checkout processing is explained below. In the checkout processing, the POS terminal 301 registers commodities, commodity codes of which are input from the CCD scanner 303 or the barcode scanner 302. Specifically, the POS terminal 301 reads out commodity information (names, unit prices, etc.) of the commodities, the commodity codes of which are received, from the commodity-information storing unit 341a, generates sales data including the commodity codes, the commodity names, and the unit prices using the read-out commodity information, and causes the storing unit such as the RAM 323 to store the sales data. In this way, the POS terminal 301 registers the commodities. The CCD scanner 303 reads, according to operation by the store clerk, provisionally registered commodity specifying information 800j displayed in a form of a two-dimensional code on the provisional receipt 800 and inputs the read information to the POS terminal 301. The barcode scanner 302 reads, according to operation by the store clerk, a commodity code displayed in a form of a barcode on a commodity not provisionally registered by the portable terminal 100 and inputs the read commodity code to the POS terminal 301. If plural commodity codes are included in the provisionally registered commodity specifying information 800j, the CPU 321 generates sales data for each of the commodity codes and registers commodities.

Subsequently, the POS terminal 301 performs settlement for the commodities registered by the POS terminal 301. Specifically, when a closing key of the keyboard 336 is depressed, the POS terminal 301 calculates a total sales price of the registered commodities and causes the displays 337 and 339 to display the total sales prices. When input of a deposit amount equal to or larger than the total sales price is performed via the keyboard 336 according to operation by the store clerk, the POS terminal 301 receives the input amount to perform settlement of the commodities. The POS terminal 301 issues, with the receipt and journal printer 340, a receipt on which predetermined contents including sales data are displayed. The POS terminal 301 generates journal data related to a transaction including the total sales price, records the generated journal data on a journal sheet with the receipt and journal printer 340, and opens the drawer.

As explained above, before the checkout processing in the POS terminal 301, commodities are provisionally registered by the portable terminal 100 operated by the store clerk. This makes it possible to provisionally register, while the checkout processing for a certain customer is performed by the POS terminal 301, commodities of another customer with the portable terminal 100. Therefore, it is possible to efficiently perform the checkout processing and reduce checkout time.

As explained above, in this embodiment, the readout unit 441 reads out the operation unit information from the operation-unit-information storing unit 434b. The data generating unit 442 generates print data of the barcode sheet 900. The data output unit 443 outputs the print data to the printer 600. Therefore, it is possible to cause the printer 600, which receives the print data, to issue the barcode sheet 900. Since it is possible to create the barcode sheet 900 by diverting the operation unit information to the barcode sheet 900, work for inputting a barcode only to create the barcode sheet 900 is unnecessary and work for sticking a barcode sticker to a sheet is unnecessary. This makes it possible to relatively easily create the barcode sheet 900. Issuance of such a barcode sheet 900 is performed in the store, for example, when the setting of the preset buttons 360a of the barcode scanner 302 is performed anew or when the setting is changed.

If the store clerk performs registration work for commodities in the settlement apparatus 300 almost every day, the store clerk memorizes the positions of the preset buttons 360a of the barcode scanner 302 in use. With attention paid to this point, in this embodiment, as explained above, the array of the plural code display sections 900a including the barcodes 900c corresponding to the preset buttons 360a in the barcode sheet 900 is set the same as the array of the preset buttons 360a. Therefore, the store clerk can easily find a desired barcode 900c from the barcode sheet 900. Since the store clerk can perform work such as registration of commodities in a relatively short time making use of the barcode sheet 900, it is possible to realize improvement of workability.

When the store purchases and sells anew a commodity not attached with a barcode, the store clerk operates the store server 400 and performs setting of the preset buttons 360a. In this case, judging from the point explained above, if the store does not change the setting of the preset buttons 360a that are already set and do not need to be changed, it is possible to further improve workability of work such as provisional registration of commodities making use of the barcode sheet 900.

In this embodiment, on the barcode sheet 900, the related information corresponding to the barcodes 900c are displayed as the character information 900b for each of the barcodes 900c. Therefore, the operator can obtain the related information concerning the barcodes 900c by reading the character information 900b.

The present invention is not limited to the embodiment. Various other embodiments can be adopted without departing from the spirit of the present invention. For example, the apparatus including the operation units is not limited to the barcode scanner and may be a keyboard including plural keys on which information is displayed. In this case, the keys of the keyboard are equivalent to the plural operation units configured to receive selection operation. Further, the plural operation units may include both the keys of the keyboard and the operation units displayed on the display explained in the embodiment.

The code symbols displayed on the code symbol display medium only have to be signs or patterns from which a data processing apparatus such as a computer can acquire data. The code symbols are not limited to the barcodes and may be two-dimensional codes or the like.

In the example explained in the embodiment, the information processing apparatus including the readout unit, the data generating unit, and the data output unit is applied to the store server. However, the information processing apparatus including the readout unit, the data generating unit, and the data output unit is not limited to this and may be applied to a barcode scanner or a POS terminal.

In the embodiment, the printer provided separately from the store server is explained as an example of the output unit. However, the output unit is not limited to this and may be a printer included in the store server. Further, the output unit may be a display, an information recording medium, or the like.

The code symbol display medium is not limited to the sheet and may be formed of a rewrite display medium on which information can be printed and erased according to thermal energy applied to the rewrite display medium.

The computer programs executed in the portable terminal, the POS terminal, the store server, and the like according to the embodiment may be provided while being recorded in a computer-readable recording medium such as a CD-ROM, a flexible disk (FD), a CD-R, or a DVD in a file of an installable format or an executable format.

The computer programs executed in the portable terminal, the POS terminal, the store server, and the like according to the embodiment may be provided by being stored on a computer connected to a network such as the Internet and downloaded through the network.

The computer programs executed in the portable terminal, the POS terminal, the store server, and the like according to the embodiment may be provided or distributed through the network such as the Internet.

According to the embodiment, it is possible to relatively easily create a code symbol display medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a readout unit configured to read out, from a storing unit, operation unit information including pieces of allocated information respectively allocated to plural operation units configured to receive selection operation;
a data generating unit configured to generate print data of a code symbol display medium on which code symbols obtained by respectively symbolizing the pieces of allocated information are displayed; and
a data output unit configured to output the print data to an output unit.

2. The apparatus according to claim 1, wherein
the operation unit information includes array information of the operation units, and
an array of the code symbols is the same as an array of the plural operation units corresponding to the code symbols.

3. The apparatus according to claim 1, wherein
the readout unit reads out related information concerning the allocated information from a second storing unit having stored therein the related information, and
the code symbol display medium displays the related information corresponding to the code symbols as character information for each of the code symbols.

4. The apparatus according to claim 1, wherein the code symbol display medium includes the code symbols that indicate commodity identification information.

5. The apparatus according to claim 1, wherein the code symbol display medium includes the code symbols that indicate discount information concerning commodities.

6. A commodity information processing system comprising:
an information processing apparatus including:
a readout unit configured to read out, from a storing unit, operation unit information including commodity identification information, which is identification information concerning commodities, and including pieces of allocated information respectively allocated to plural operation units configured to receive selection operation;
a data generating unit configured to generate print data of a code symbol display medium on which code symbols obtained by respectively symbolizing the pieces of allocated information are displayed; and
a data output unit configured to output the print data;
an output unit configured to issue the code symbol display medium using the print data output by the data output unit;
a portable terminal configured to read the code symbols displayed on the code symbol display medium issued by the output unit; and
a settlement apparatus configured to perform settlement of the commodities, the code symbols of which are read by the portable terminal.

7. The system according to claim 6, wherein
the operation unit information includes array information of the operation units, and
an array of the code symbols is the same as an array of the plural operation units corresponding to the code symbols.

8. The system according to claim 6, wherein
the readout unit reads out related information concerning the allocated information from a second storing unit having stored therein the related information, and
the code symbol display medium displays the related information corresponding to the code symbols as character information for each of the code symbols.

9. The system according to claim 6, wherein the code symbol display medium includes the code symbols that indicate discount information concerning commodities.

10. An information processing method comprising:
a readout unit reading out, from a storing unit, operation unit information including pieces of allocated information respectively allocated to plural operation units configured to receive selection operation;
a data generating unit generating print data of a code symbol display medium on which code symbols obtained by respectively symbolizing the pieces of allocated information are displayed; and
a data output unit outputting the print data to an output unit.

11. A commodity information processing method executed by a commodity information processing system including:
an information processing apparatus including a readout unit, a data generating unit, and a data output unit;
an output unit;
a portable terminal; and
a settlement apparatus,
the commodity information processing method comprising:
the readout unit reading out, from a storing unit, operation unit information including commodity identification information, which is identification information concerning commodities, and including pieces of allocated information respectively allocated to plural operation units configured to receive selection operation;
the data generating unit generating print data of a code symbol display medium on which code symbols obtained by respectively symbolizing the pieces of allocated information are displayed;
the data output unit outputting the print data;
the output unit issuing the code symbol display medium using the print data output by the data output unit;
the portable terminal reading the code symbols displayed on the code symbol display medium issued by the output unit; and
the settlement apparatus performing settlement of the commodities, the code symbols of which are read by the portable terminal.
